(19) United States
(12) Patent Application Publication
(10) Pub. No.: US 2007/0025556 A1
(43) Pub. Date: Feb. 1, 2007

(54) Sound source separation apparatus and sound source separation method

(75) Inventor: Takashi Hiekata, Kobe-shi (JP)

Correspondence Address: REED SMITH LLP, 3110 FAIRVIEW PARK DRIVE, SUITE 1400, FALLS CHURCH, VA, 22042, US

(73) Assignee: Kabushiki Kaisha Kobe Seiko Sho

(21) Appl. No.: 11/489,441

(22) Filed: Jul. 20, 2006

(30) Foreign Application Priority Data
Jul. 26, 2005 (JP) 2005216391

(51) Int. Cl. H04R 5/00

(52) U.S. Cl. 381/17

(57) ABSTRACT

A sound source separation apparatus includes a first sound source separation unit that performs blind source separation based on independent component analysis to separate a sound source signal from a plurality of mixed sound signals, thereby generating a first separated signal; a second sound source separation unit that performs real-time sound source separation by using a method other than the blind source separation based on independent component analysis to generate a second separated signal; and a multiplexer that selects one of the first separated signal and the second separated signal as an output signal. The first sound source separation unit continues processing regardless of the selection state of the multiplexer. When the first separated signal is selected as an output signal, the number of sequential calculations of a separating matrix performed in the first sound source separation unit is limited to a number that allows for real-time processing.

### BACKGROUND OF THE INVENTION

1. Field of the Invention

The present invention relates to a sound source separation apparatus and a sound source separation method.

2. Description of the Related Art

In a space that accommodates a plurality of sound sources and a plurality of microphones, each microphone receives a sound signal in which individual sound signals from the sound sources (hereinafter referred to as “sound source signals”) overlap each other. Hereinafter, the received sound signal is referred to as a “mixed sound signal”. A method of identifying (separating) individual sound source signals on the basis of only the plurality of mixed sound signals is known as a “blind source separation method” (hereinafter simply referred to as a “BSS method”).

In addition, among a plurality of sound source separation processes based on the BSS method, a sound source separation process of a BSS method based on the independent component analysis method (hereinafter simply referred to as “ICA”) has been proposed. In the BSS method based on ICA (hereinafter referred to as “ICA-BSS”), a predetermined separating matrix (an inverse mixture matrix) is optimized using the fact that the sound source signals are independent from each other. The plurality of sound source signals input from a plurality of microphones are subjected to a filtering operation using the optimized separating matrix so that the sound source signals are identified (separated). At that time, the separating matrix is optimized by calculating a separating matrix that is subsequently used in a sequential calculation (learning calculation) on the basis of the signal (separated signal) identified (separated) by the filtering operation using a separating matrix set at a given time.

The sound source separation process of the ICA-BSS can provide a high sound source separation performance (the performance of identifying the sound source signals) if the sequential calculation (learning calculations) for obtaining a separating matrix is sufficiently carried out.

However, achieving a sufficient level of sound source separation performance requires an increased number of sequential calculations (learning calculations) for determining a separating matrix to be used for separation (filtering) and thus increases the computing load. Performing such calculations by a widely used processor takes a long time that is several times the time length of input mixed sound signals. This means that ICA-BSS has a problem in that it is not suitable for real-time processing. The computing load in determining a separating matrix for achieving a sufficient level of sound source separation performance is particularly high during a certain period of time after the start of processing or in the case where there is a change in audio environment (e.g., the movement, addition, or modification of a sound source). In other words, a larger number of sequential calculations are required for the convergence of a separating matrix in the initial state of the separating matrix or in the case of a change in audio environment. Under conditions where the convergence state (learning state) of the separating matrix is insufficient, the performance of ICA-BSS can be even lower than that of other methods of sound source separation, such as the above-described binary masking and the like that are suitable for real-time processing and relatively simple.

On the other hand, other methods of sound source separation, such as binary masking, passband filtering, beamformer, and the like can be performed by using only momentary mixed sound signals of several milliseconds to several hundreds of milliseconds in duration at the maximum. These methods are low in computing load, suitable for real-time processing, and less subject to changes in audio environment. As described above, with some methods other than ICA-BSS, real-time processing can be achieved by a widely used processor embedded in products, and a relatively stable level of sound source separation performance can be achieved even at the beginning of processing or under conditions where the audio environment changes. However, such methods of sound source separation have a problem in that their level of sound source separation performance is lower than that of ICA-BSS where the learning of the separating matrix has been performed to a sufficient degree.

### SUMMARY OF THE INVENTION

The present invention has been made in view of the circumstances described above, and an object thereof is to provide a sound source separation apparatus and a sound source separation method that can maximize sound source separation performance while allowing real-time processing.

To achieve the object described above, the present invention is directed to a sound source separation apparatus and to a sound source separation method for performing processing (sound input) for receiving a plurality of mixed sound signals, sound source signals from a plurality of sound sources being overlapped in each of the mixed sound signals; processing (separating matrix calculation) for sequentially determining a separating matrix by performing learning calculations of the separating matrix, in the process of blind source separation based on independent component analysis using a predetermined time length of the mixed sound signals; processing (first sound source separation) for sequentially generating a separated signal corresponding to a sound source signal from the plurality of mixed sound signals by matrix calculations using the separating matrix determined in the process of the separating matrix calculation; and processing (second sound source separation) for sequentially generating a separated signal corresponding to a sound source signal from the plurality of mixed sound signals by performing real-time sound source separation using a method other than ICA-BSS. The separated signal generated in the first sound source separation or the separated signal generated in the second sound source separation is selected as the output signal.

In the processing described above, under conditions where the degree of convergence (learning) of the separating matrix in the process of the first sound source separation (ICA-BSS) is insufficient, a separated signal based on the second sound source separation (e.g., binary masking, passband filtering, or beamformer) which can be performed on a real-time basis and can ensure stable sound source separation performance is selected as an output signal while, at the same time, learning (sequential calculations) of the separating matrix used in the first sound source separation is performed. Therefore, when the degree of convergence of the separating matrix has become sufficient, a separated signal based on the first sound source separation that can ensure a high level of sound source separation performance can be selected as an output signal.

Thus, sound source separation performance can be maximized while real-time processing can be achieved.

In the process of the separating matrix calculation described above, every time a predetermined time period of the mixed sound signals (corresponding to “Frame” described below) are input, all the input signals may be used to perform the learning calculations of the separating matrix, and the maximum number of the learning calculations may be set such that the calculations can be completed within the predetermined time period.

This allows the learning calculations (i.e., updating) of the separating matrix to be performed in a short period of time (i.e., time required for the learning calculations can be reduced). Even if there is a change in the state of the sound sources, the operation is quickly performed in response to such a change, and a high level of sound source separation performance can be ensured. Once the sufficient convergence (learning) of the separating matrix has been achieved, a high level of sound source separation performance can be maintained even if the number of times of learning (the number of sequential calculations) is subsequently limited, unless there is a considerable change in audio environment.

On the other hand, in the process of the separating matrix calculation described above, every time a predetermined time period of the mixed sound signals are input, the input signals corresponding to only a part of the predetermined time period may be used to perform the learning calculations of the separating matrix.

This also allows the learning calculations (i.e., updating) of the separating matrix to be performed in a short period of time. Even if there is a change in the state of the sound sources, the operation is quickly performed in response to such a change, and a high level of sound source separation performance can be ensured. Although it is generally preferable that all the mixed sound signals sequentially input be reflected in the learning calculations, a sufficient level of sound source separation performance can be ensured with the learning calculations using part of the mixed sound signals, unless the level of change in the sound sources is not significant.

For example, during a time period from the beginning of the initial learning calculation of the separating matrix in the process of the separating matrix calculation until the predetermined number of learning calculations is reached or until a predetermined time elapses, a separated signal generated in the process of the second sound source separation may be selected as an output signal, and subsequently, a separated signal generated in the process of the first sound source separation may be selected as an output signal.

In this case, from the beginning of the processing until a sufficient degree of convergence (learning) of the separating matrix in the first sound source separation is achieved, a separated signal based on the second sound source separation that can ensure stable sound source separation performance is selected as an output signal, and subsequently, a separated signal based on the first sound source separation that has achieved a high level of sound source separation performance is selected as an output signal.

Moreover, a separated signal generated in the first sound source separation or a separated signal generated in the second sound source separation may be selected as an output signal, according to the degree of convergence of the learning calculations performed in the process of separating matrix calculation. The degree of convergence of the learning calculations may be evaluated on the basis of a change (gradient) in evaluation value, which is determined every time the learning calculations are performed.

In this case, the first sound source separation that can ensure a high level of sound source separation performance is selected under conditions (e.g., stable audio environment) where a sufficient level of convergence can be achieved even if the learning calculations are performed in a relatively short period of time, while the second sound source separation is selected under conditions (e.g., a certain period of time after the start of processing or in the case where there is a significant change in audio environment) where the level of convergence of the learning calculations is not sufficient. In other words, an appropriate method of sound source separation can be selected depending on the situation. Thus, sound source separation performance can be maximized while real-time processing can be achieved.

Moreover, for the determination of such a switching operation, different threshold values of the degree of convergence of the separating matrix may be used, depending on whether the separated signal selected as the output signal is switched from that generated in the first sound source separation to that generated in the second sound source separation, or switched in the opposite direction. In other words, such a switching operation may be performed with hysteresis characteristics.

This can prevent the degree of convergence of the separating matrix from varying about a predetermined threshold value, and thus can eliminate the problem of unstable processing conditions resulting from frequent changes in the method of sound source separation during a short period of time.

In the present invention, processing to be performed for determining sound source separation signals (output signals) to be output is switched, according to the situation, between ICA-BSS that can achieve a higher level of sound source separation performance if the separating matrix is sufficiently learned, and another method of sound source separation (such as binary masking) that is low in computing load, suitable for real-time processing, and can ensure stable sound source separation performance regardless of changes in audio environment. This can maximize sound source separation performance while enabling real-time processing.

For example, if such a switching operation is performed on the basis of the degree of convergence of the separating matrix in ICA-BSS, sound source separation appropriate for the convergence state of the separating matrix (e.g., the convergence state during a certain period of time after the start of processing or in the case where there is a significant change in audio environment, or the convergence state in the other cases) can be selected. This can maximize sound source separation performance while ensuring real-time processing. Moreover, if a threshold value for the convergence level of the separating matrix is varied depending on the direction in which such a switching operation is performed (i.e., switching from ICA-BSS to the other method of sound source separation, or the other way around), a problem of unstable processing conditions resulting from frequent changes in the method of sound source separation during a short period of time can be avoided.

In the claims, means-plus-function clauses are intended to cover any structure described herein as performing the corresponding function of the present invention.

### BRIEF DESCRIPTION OF THE DRAWINGS

FIG. 1 is a block diagram of a sound source separation apparatus X according to an embodiment of the present invention.

FIG. 2 is a flowchart illustrating sound source separation performed by the sound source separation apparatus X.

FIG. 3A and FIG. 3B are time diagrams illustrating a first example of separating matrix calculations performed by a first sound source separation unit of the sound source separation apparatus X.

FIG. 4A and FIG. 4B are time diagrams illustrating a second example of separating matrix calculations performed by the first sound source separation unit of the sound source separation apparatus X.

FIG. 5 is a block diagram of a sound source separation apparatus Z1, which performs BSS based on a time-domain independent component analysis (TDICA).

FIG. 6 is a block diagram of a sound source separation apparatus Z2, which performs sound source separation based on a frequency-domain independent component analysis (FDICA).

FIG. 7 illustrates binary masking.

### DESCRIPTION OF THE PREFERRED EMBODIMENTS

Embodiments of the present invention will now be described with reference to the accompanying drawings for aid in understanding the present invention. The following embodiments are provided for exemplary purposes and are not intended to limit the technical scope of the present invention.

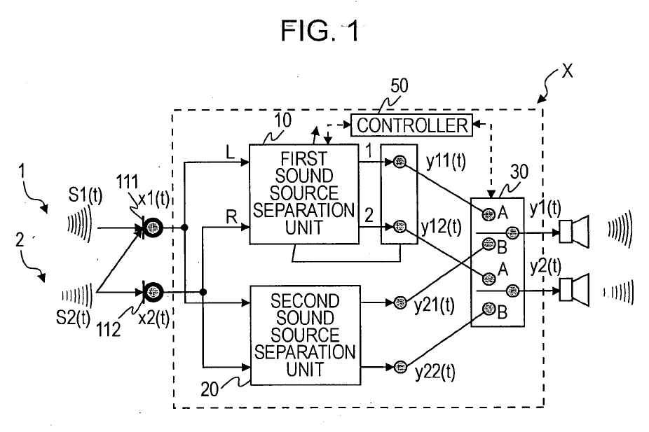

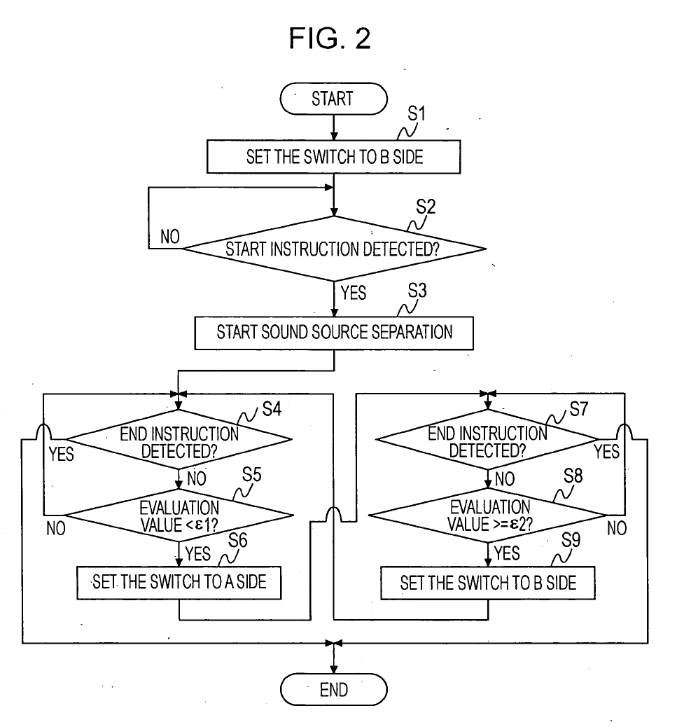

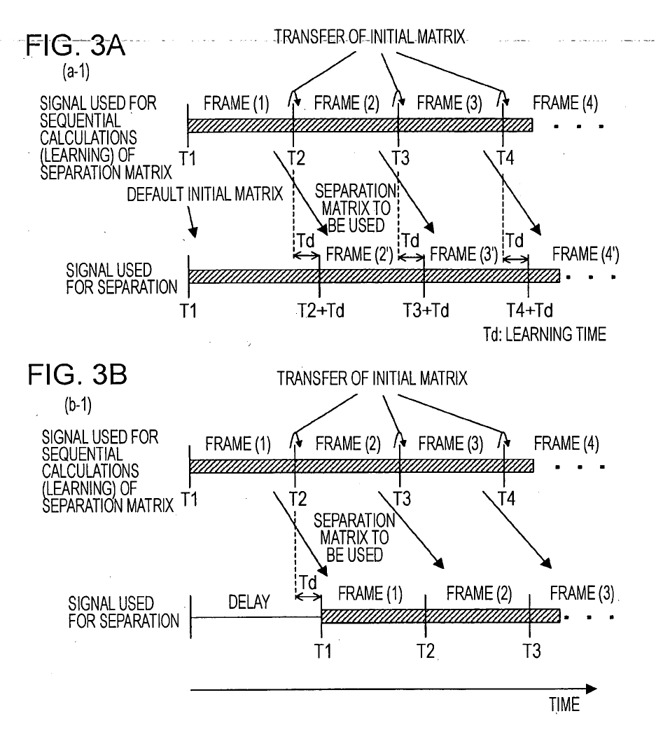

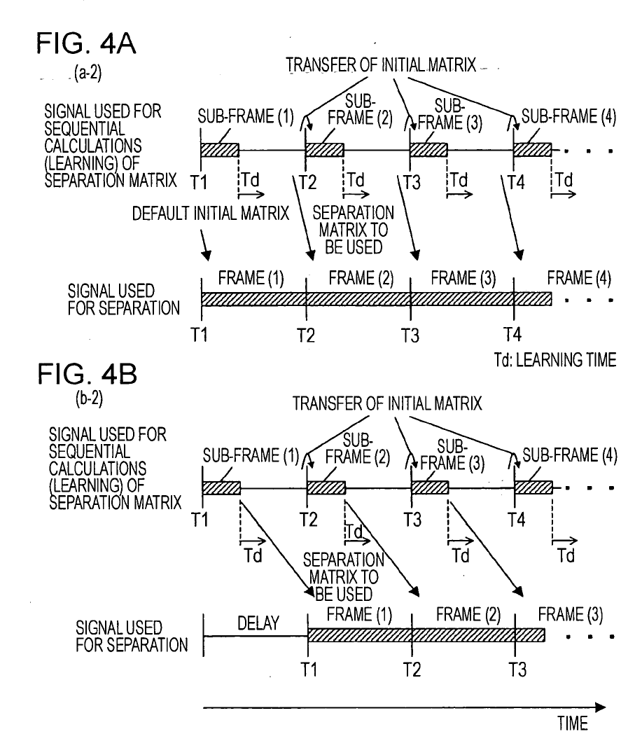

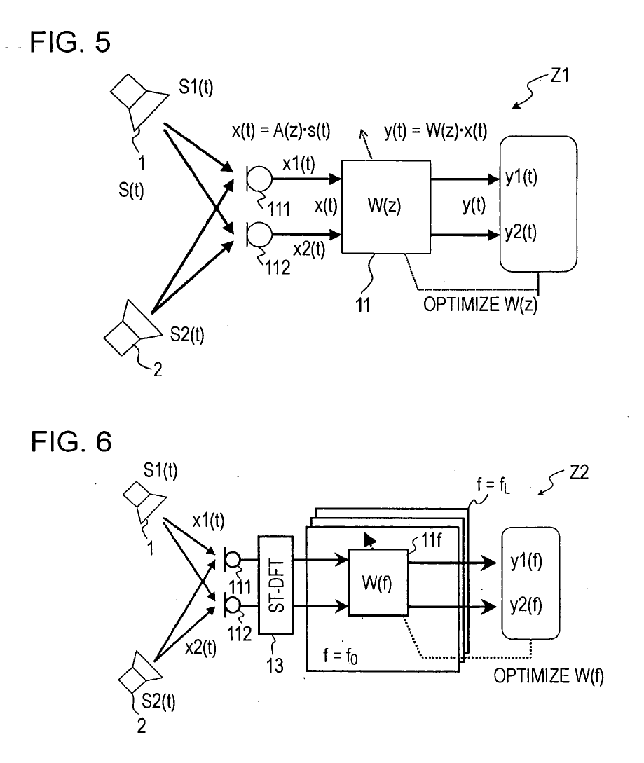

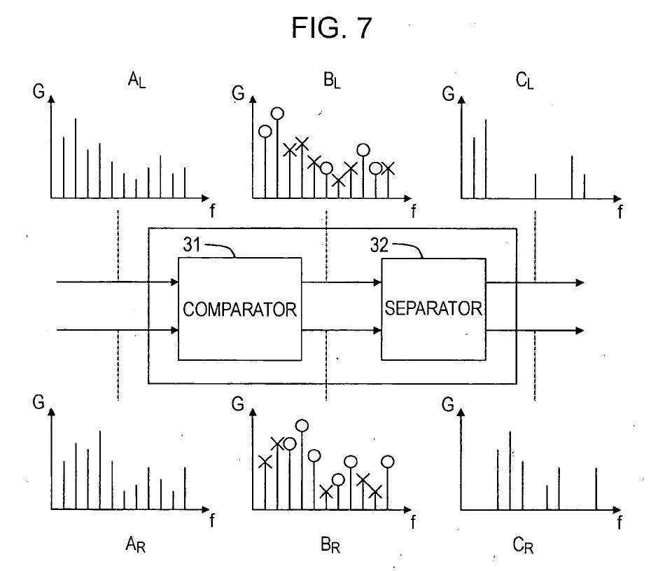

FIG. 1 is a block diagram of a sound source separation apparatus X according to an embodiment of the present invention. FIG. 2 is a flowchart illustrating sound source separation performed by the sound source separation apparatus X. FIG. 3A and FIG. 3B are time diagrams illustrating a first example of separating matrix calculations performed by a first sound source separation unit of the sound source separation apparatus X. FIG. 4A and FIG. 4B are time diagrams illustrating a second example of separating matrix calculations performed by the first sound source separation unit of the sound source separation apparatus X. FIG. 5 is a block diagram of a sound source separation apparatus Z1, which performs BSS based on TDICA. FIG. 6 is a block diagram of a sound source separation apparatus Z2, which performs sound source separation based on FDICA. FIG. 7 illustrates binary masking.

Before embodiments of the present invention are described, exemplary sound source separation apparatuses that perform various types of ICA-BSS, which is applicable as an element of the present invention, is described with reference to the block diagrams in FIG. 5 and FIG. 6.

Sound source separation and apparatuses that perform the sound source separation are applied in an environment in which a plurality of sound sources and a plurality of microphones (sound input means) are placed in a predetermined acoustic space. In addition, the sound source separation and the apparatuses executing the sound source separation relate to those that generate one or more separated signals separated (identified) from a plurality of mixed sound signals including overlapped individual sound signals (sound source signals) input from the microphones.

FIG. 5 is a block diagram illustrating a schematic configuration of a known sound source separation apparatus Z1 that performs BSS based on TDICA, which is one type of ICA.

The sound source separation apparatus Z1 receives sound source signals S1(t) and S2(t) (sound signals from corresponding sound sources) from two sound sources 1 and 2, respectively, via two microphones (sound input means) 111 and 112. A separation filtering processing unit 11 carries out a filtering operation on 2-channel mixed sound signals x1(t) and x2(t) (the number of channels corresponds to the number of the microphones) using a separating matrix W(z).

FIG. 5 illustrates an example in which sound source separation is performed on the basis of the 2-channel mixed sound signals x1(t) and x2(t) containing the sound source signals S1 (t) and S2 (t) received from the sound sources 1 and 2, respectively, via the two microphones 111 and 112. However, the same can be applied to the case in which there are more than two channels. Let n denote the number of input channels of a mixed sound signal (i.e., the number of microphones), and let m denote the number of sound sources. In the case of ICA-BSS, it should be satisfied that n≧m.

In each of the mixed sound signals x1(t) and x2(t) respectively collected by the microphones 111 and 112, the sound source signals from the sound sources are overlapped. Hereinafter, the mixed sound signals x1(t) and x2(t) are collectively referred to as “x(t)”. The mixed sound signal x(t) is represented as a temporal and spatial convolutional signal of a sound source signal S(t) and given by Equation (1) as follows:
x(t)=A(z)·S(t) Equation (1)
where A(z) represents a spatial matrix used when signals from the sound sources are input to the microphones.

The theory of TDICA-based sound source separation employs the fact that the sound sources in the sound source signal S(t) are statistically independent. That is, if x(t) is obtained, S(t) can be estimated. Therefore, the sound sources can be separated.

Here, let W(z) denote the separating matrix used for the sound source separation. Then, a separated signal (i.e., identified signal) y(t) is expressed by Equation (2) as follows:
y(t)=W(z)·x(t) Equation (2)

Here, the separating matrix W(z) can be obtained by performing sequential calculations (learning calculations) on the separated signal y(t). The separated signals can be obtained for the number of channels.

It is noted that, to perform a sound source combining process, a matrix corresponding to the inverse calculation is generated from information about W(z), and the inverse calculation is carried out using this matrix. Additionally, to perform the sequential calculation, a predetermined value is used as an initial value of the separating matrix (an initial matrix).

By performing a sound source separation using such an ICA-BSS, from, for example, mixed sound signals for a plurality of channels including human singing voice and a sound of an instrument (such as a guitar), the sound source signals of the singing voice is separated (identified) from the sound source signals of the instrument.

Equation (2) can be rewritten to Equation (3) as follows:

$$y ( t ) = {\sum }_{n = 0}^{D - 1} w ( n ) x ( t - n ) \qquad Equation ( 3 )$$

where D denotes the number of taps of a separating filter w(n).

The separating filter (separating matrix) w(n) in Equation (3) is sequentially calculated by Equation (4) as follows:

$${w}^{[ j + 1 ]} ( n ) = {w}^{[ j ]} ( n ) - α {\sum }_{d = 0}^{D - 1} \{ off - diag {〈 φ ( {y}^{[ j ]} ( t ) ) {{y}^{[ j ]} ( t - n + d )}^{T} 〉}_{t} \} \cdot {w}^{[ j ]} ( d ) \qquad Equation ( 4 )$$

where α denotes an update coefficient, [j] denotes the number of updates, <•••>ₜ denotes a time-averaging operator, “off-diag X” denotes a calculation for replacing all diagonal elements of a matrix X with zero, and φ(•••) denotes an appropriate nonlinear vector function having an element such as a sigmoidal function.

That is, by sequentially applying the separated signal y(t) of the previous (j) to Equation (4), w(n) for the current (j+1) is obtained.

Next, a known sound source separation apparatus Z2 that performs sound source separation based on a frequency-domain ICA (FDICA), which is one type of ICA, will be described with reference to the block diagram in FIG. 6.

In the FDICA method, the input mixed sound signal x(t) is subjected to a short time discrete Fourier transform (ST-DFT) on a frame-by-frame basis. The frame is a signal obtained by separating the input mixed sound signal x(t) by predetermined periods of time by means of a ST-DFT processing unit 13. Thereafter, the observed signal is analyzed in a short time. After the SF-DFT is carried out, a signal of each channel (a signal of a frequency component) is subjected to separation filtering based on the separating matrix W(f) by a separation filtering processing unit 11f. Thus, the sound sources are separated (i.e., the sound source signals are identified). Here, let f denote the frequency range and m denote the analysis frame number. Then, a separated signal (identified signal) Y(f, m) is expressed by Equation (5) as follows:
Y(f,m)=W(f)·X(f,m) Equation (5)

Here, the update equation of the separating filter W(f) can be expressed, for example, by Equation (6) as follows:
W_{(ICAl)}^{[i+1]}(f)=W_{(ICAl)}^{[i]}(f)−η(f)[off-diag{ [symbol] φ(Y_{(ICAl)}^{[i]}(f,m))Y_{(ICAl)}^{[i]}(f,m)^{H} [symbol] ₘ}]W_{(ICAl)}^{[i]}(f) Equation (6)
where η(f) denotes an update coefficient, [i] denotes the number of updates, <•••>ₘ denotes a time-averaging operator, H denotes the Hermitian transpose, “off-diag X” denotes a calculation for replacing all diagonal elements of a matrix X with zero, and φ(•••) denotes an appropriate nonlinear vector function having an element such as a sigmoidal function.

According to the FDICA method, the sound source separation is regarded as instantaneous mixing problems in narrow bands. Thus, the separating filter (separating matrix) W(f) can be relatively easily and reliably updated.

In addition to the above-described methods of sound source separation, such as those based on TDICA and FDICA and multistage ICA-BSS, any other methods of sound source separation based on an algorithm not deviating from the basic concept of ICA-BSS performed by evaluating the independence of sound sources can be regarded as ICA-BSS, which is applicable as an element of the present invention.

A sound source separation apparatus X according to an embodiment of the present invention will now be described with reference to the block diagram in FIG. 1.

In a given acoustic space where there are a plurality of sound sources 1 and 2 and a plurality of microphones (sound input means) 111 and 112, the sound source separation apparatus X receives a plurality of mixed sound signals Xi(t), in which sound source signals (individual sound signals) from the sound sources 1 and 2 overlap each other, via the respective microphones 111 and 112, separates (identifies) a sound source signal from the mixed sound signals Xi(t) to sequentially generate and output a separated signal (i.e., identified signal corresponding to the sound source signal) “y” as an output signal to a speaker (sound output means) on a real-time basis. The sound source separation apparatus X can be applied, for example, to a handsfree phone and a sound pickup device for teleconferences.

As illustrated in FIG. 1, the sound source separation apparatus X includes a first sound source separation unit (exemplary first sound source separating means) 10 and a second sound source separation unit (exemplary second sound source separating means) 20. The first sound source separation unit 10 (which serves as an exemplary separating matrix calculating means) uses a predetermined time period of mixed sound signals Xi(t) to perform learning calculations of a separating matrix W in the process of ICA-BSS, sequentially determines the separating matrix W, uses the separating matrix W obtained by the learning calculations to perform matrix calculations, and sequentially separates (identifies) a sound source signal Si(t) from the plurality of mixed sound signals Xi(t) to generate a separated signal y1i(t) (hereinafter referred to as “first separated signal”). The second sound source separation unit 20 performs real-time sound source separation using a method other than the ICA-BSS to sequentially generate, from the plurality of mixed sound signals Xi(t), a separated signal y2i(t) (hereinafter referred to as “second separated signal”) corresponding to the sound source signal Si(t).

Examples of methods used in the first sound source separation unit 10 for the determination of a separating matrix and for the separation of sound sources include BSS based on TDICA illustrated in FIG. 5 and BSS based on FDICA illustrated in FIG. 6.

Examples of methods used in the second sound source separation unit 20 for sound source separation include known bandlimiting filtering, binary masking, beamformer processing, and the like that are low in computing load and can be performed on a real-time basis by a general embedded-type calculating unit.

For example, in delay-and-sum beamformer that can be used as a method of sound source separation in the second sound source separation unit 20, if a plurality of sound sources are spatially separate, time intervals between wavefronts reaching the microphones 111 and 112 are adjusted by a delay unit such that the sound sources to be identified are emphasized and separated.

If there are less overlaps in the frequency bands of sound source signals to be separated, passband filtering (bandlimiting filtering) can be used as a method of sound source separation in the second sound source separation unit 20.

For example, if the frequency bands of two sound source signals are roughly divided into two regions, one is below and the other is above or equal to a predetermined threshold frequency, one of two mixed sound signals is input to a low-pass filter that allows only signals at frequencies below the threshold frequency to pass through, and the other of the two mixed sound signals is input to a high-pass filter that allows only signals at frequencies above or equal to the threshold frequency to pass through. This allows the generation of separated signals corresponding to respective sound source signals.

FIG. 7 illustrates binary masking that can be used as a method of sound source separation in the second sound source separation unit 20. The binary masking is an exemplary method of signal processing derived from the idea of binaural signal processing, relatively simple, and suitable for real-time processing. Signal separation performed by the binaural signal processing involves the application of time-varying gain control to the mixed sound signals on the basis of a human auditory model, thereby performing sound source separation. A device or a program that executes binary masking includes a comparator 31 and a separator 32. The comparator 31 compares a plurality of input signals (equivalent to the plurality of mixed sound signals Xi(t) in the present invention). The separator 32 applies gain control to the input signals on the basis of the result of comparison performed by the comparator 31, thereby performing signal separation (sound source separation).

In binary masking, first, the comparator 31 detects signal level (amplitude) distributions AL and AR among frequency components with respect to each input signal, and compares signal levels at each frequency component.

Referring to FIG. 7, BL and BR each illustrate the signal level distribution among frequency components of an input signal, and indicate the result of comparison between a signal level and its corresponding signal level with symbols “O” and “x”. In FIG. 7, a signal level marked with “O” is higher than its corresponding signal level, and a signal level marked with “x” is lower than its corresponding signal level.

Next, on the basis of the result of signal level comparison performed by the comparator 31, the separator 32 performs gain multiplication (gain control) on each input signal to generate a separated signal (identified signal). An example of the simplest processing in the separator 32 is to multiply, with respect to each frequency component, the frequency component of an input signal having the highest signal level by a gain of one, and to multiply the same frequency component of the other input signal by a gain of zero.

This produces separated signals (identified signals) CL and CR as many as the input signals. Of the two separated signals CL and CR, one corresponds to a sound source signal subjected to identification in the input signals, while the other corresponds to noise (i.e., sound source signal other than the sound source signal subjected to identification) contained in the input signals.

Although FIG. 7 illustrates exemplary binary masking based on two input signals, the same applies to binary masking based on three or more input signals.

The sound source separation apparatus X further includes a multiplexer 30 (exemplary output switching means) for selecting the first separated signal y1i(t) generated by the first sound source separation unit 10 or the second separated signal y2i(t) generated by the second sound source separation unit 20 as an output signal yi(t).

Regardless of the separated signal selected by the multiplexer 30, at least the processing performed by the first sound source separation unit 10 continues. Therefore, even when the second separated signal y2i(t) is selected as the output signal yi(t), the first sound source separation unit 10 continues performing, on the basis of the first separated signal y1i(t) generated by the first sound source separation unit 10, sequential calculations (learning calculations) of the separating matrix W (e.g., W(Z) illustrated in FIG. 5 or W(f) illustrated in FIG. 6) to be used in generating the subsequent first separated signal y1i(t).

The sound source separation apparatus X further includes a controller 50, which obtains from the multiplexer 30 information indicating the state of signal selection and transmits the obtained information to the first sound source separation unit 10. At the same time, the controller 50 monitors the convergence state (learning state) of the separating matrix W and controls the switching of the multiplexer 30 according to the observed convergence state.

Although FIG. 1 illustrates an example in which the number of channels is two (i.e., the number of microphones is two), a similar configuration can be used in cases where the number of channels is three or more, as long as the number of channels “n” of mixed sound signals to be input (i.e., the number of microphones) is equal to or larger than the number of sound sources “m”.

Each of the first sound source separation unit 10, second sound source separation unit 20, multiplexer 30, and controller 50 may be configured to include a digital signal processor (DSP) or a central processing unit (CPU), peripherals (e.g., a read-only memory (ROM) and a random-access memory (RAM)), and a program to be executed by the DSP or CPU. It is also possible that a computer including a single CPU and its peripherals executes a program module corresponding to processing performed by each of the components (10, 20, 30, and 50) described above. Each of the components may be supplied to a predetermined computer in the form of a sound source separation program that enables the computer to execute the processing of each component.

FIG. 2 is a flowchart illustrating a procedure of sound source separation in the sound source separation apparatus X. The sound source separation apparatus X is included in an apparatus, such as a handsfree phone. The controller 50 of the sound source separation apparatus X obtains the operating state of an operating part (e.g., operating buttons) of the apparatus. Upon detection of a predetermined processing start operation (i.e., start instruction) through the operating part of the apparatus, the sound source separation apparatus X starts sound source separation. Upon detection of a predetermined processing end operation (i.e., end instruction) through the operating part of the apparatus, the sound source separation apparatus X terminates the sound source separation. In FIG. 2, S1, S2, . . . are identification codes, each representing a processing procedure (step).

When the sound source separation apparatus X is started, for example, by turning the power on, the multiplexer 30 sets a signal switching state (output selection state) to a “B” side, which allows the second separated signal y2i(t) generated by the second sound source separation unit 20 to be output as the output signal yi(t) (step S1).

Next, the first and second sound source separation units 10 and 20 wait until the controller 50 detects a start instruction (processing start operation) (step S2). Upon detection of the start instruction, the first and second sound source separation units 10 and 20 start sound source separation (step S3).

This also allows the first sound source separation unit 10 to start sequential calculations (learning calculations) of the separating matrix W. At the start of the calculations, the second separated signal y2i(t) generated by the second sound source separation unit 20 is selected as the output signal yi(t).

Next, the controller 50 monitors whether the end instruction has been detected (step S4 and step S7). Processing in steps S5 and S6 or steps S8 and S9 (described below) is repeated until the end instruction is detected.

Specifically, the controller 50 checks a predetermined evaluation value & indicating the degree of convergence of the separating matrix W sequentially calculated in the first sound source separation unit 10 (step S5 and step S8). According to the evaluation value ε, the multiplexer 30 selects the separated signal generated by the first sound source separation unit 10 or second sound source separation unit 20 as the output signal y.

Examples of the evaluation value ε (index) indicating the degree of convergence of the separating matrix W include that expressed by the following Equation (7). The evaluation value ε is equivalent to a coefficient multiplied to W^{[j]}(d) in the second term in the right side of Equation (4) to be used in updating the separating matrix W.

$$\vert {\sum }_{d = 0}^{D - 1} \{ off - diag {〈 φ ( {y}^{[ j ]} ( t ) ) {{y}^{[ j ]} ( t - n + d )}^{T} 〉}_{t} \} \vert = ɛ \qquad Equation ( 7 )$$

The evaluation value ε is often used as the amount of scalar indicating the degree of progress (convergence) of learning calculations. As the evaluation value ε approaches zero, the degree of convergence (degree of learning) of the separating matrix proceeds.

When the multiplexer 30 is set to the “B” side, the controller 50 checks whether the evaluation value ε is below a first threshold value ε1 (step S5). During the period in which the evaluation value ε is equal to or larger than the first threshold value ε1, the multiplexer 30 is kept at the “B” side to maintain a state in which the second separated signal y2i(t) generated by the second sound source separation unit 20 is selected as the output signal yi(t). However, if the controller 50 determines that the evaluation value ε is below the first threshold value ε1, the multiplexer 30 is switched to an “A” side, which allows the first separated signal y1i(t) generated by the first sound source separation unit 10 to be selected as the output signal yi(t) (step S6).

On the other hand, when the multiplexer 30 is set to the “A” side, the controller 50 checks whether the evaluation value ε is equal to or more than a second threshold value ε2 (step S8). During the period in which the evaluation value ε is below the second threshold value ε2, the multiplexer 30 is kept at the “A” side to maintain a state in which the first separated signal y1i(t) generated by the first sound source separation unit 10 is selected as the output signal yi(t). However, if the controller 50 determines that the evaluation value ε is equal to or more than the second threshold value ε2, the multiplexer 30 is switched to the “B” side, which allows the second separated signal y2i(t) generated by the second sound source separation unit 20 to be selected as the output signal yi(t) (step S9).

The first and second threshold values ε1 and ε2 of the evaluation value ε on which the switching of signals performed by the multiplexer 30 is based are set such that the switching of signals is performed with hysteresis characteristics. In other words, the threshold value ε2 to be used in determining the switching of the output signal yi(t) from the first separated signal y1i(t) to the second separated signal y2i(t) is different from the threshold value ε1 to be used in determining the switching in the opposite direction (ε1<ε2).

This can prevent the evaluation value ε indicating the degree of convergence of the separating matrix from varying around a predetermined threshold value (e.g., ε1), and thus can eliminate the problem of unstable processing conditions resulting from frequent changes in the method of sound source separation during a short period of time. It is not required to make the two threshold values ε1 and ε2 different from each other, and it is possible to set the two threshold values ε1 and ε2 to satisfy the equation ε1=ε2. The degree of convergence of the separating matrix may be determined not by evaluating the evaluation value ε relative to the threshold values, but on the basis of whether a change (gradient) in evaluation value ε is below a predetermined threshold value.

If an end instruction is detected during processing (“Y” in step S4 or step S7), the sound source separation apparatus X terminates the sound source separation.

Next, overviews of a first example (FIGS. 3A and 3B) and a second example (FIGS. 4A and 4B) of separating matrix calculations performed by the first sound source separation unit 10 will be described with reference to time diagrams of FIGS. 3A and 3B and FIGS. 4A and 4B.

FIGS. 3A and 3B are time diagrams illustrating the first example of the division of mixed sound signals to be used both in separating matrix calculations and sound source separation in the processing (ICA-BSS) performed by the first sound source separation unit 10.

In the first example, the mixed sound signals sequentially input are divided at predetermined intervals into “Frames”, and the first sound source separation unit 10 performs sound source separation using a separating matrix on a Frame-by-Frame basis.

FIG. 3A illustrates processing (a-1) in which Frames used in calculating (learning) the separating matrix are different from those used in generating (identifying) separated signals by performing filtering based on the separating matrix. FIG. 3B illustrates processing (b-1) in which same Frames are used in both cases.

As illustrated in FIG. 3A, in processing (a-1), Frame(i) corresponding to all the mixed sound signals input during the time period from Ti to Ti+1 (period: Ti+1−Ti) is used to calculate (learn) a separating matrix. Then, the resulting separating matrix is used to perform sound source separation (filtering) on Frame(i+1)′ corresponding to all the mixed sound signals input during the time period from (Ti+1+Td) to (Ti+2+Td), where Td denotes the time required to learn a separating matrix by using a single Frame. In other words, a separating matrix calculated on the basis of mixed sound signals input during a single predetermined time period is used to perform sound source separation (identification processing) on mixed sound signals input during the subsequent period shifted by (Frame time length)+(learning time). When a separating matrix calculated (learned) by using Frame(i) corresponding to a certain time period is used as an initial value (initial separating matrix) in calculating the separating matrix (sequential calculations) by using Frame(i+1)′ corresponding to the subsequent time period, the convergence of the sequential calculations (learning) can be accelerated, which is preferable.

On the other hand, as illustrated in FIG. 3B, in processing (b-1), Frame(i) corresponding to all the mixed sound signals input during the time period from Ti to Ti+1 is stored while being used to calculate (learn) a separating matrix. Then, the resulting separating matrix is used to perform sound source separation (filtering) on the stored Frame(i). In other words, while mixed sound signals corresponding to a single time period and learning time Td are stored in a storage unit (memory), a separating matrix is calculated (learned) on the basis of all the stored mixed sound signals corresponding to the single time period. Then, the resulting separating matrix is used to perform sound source separation (identification processing) on the mixed sound signals corresponding to the single time period stored in the storage unit. Again, it is preferable that a separating matrix calculated (learned) by using Frame(i) corresponding to a certain time period be used as an initial value (initial separating matrix) in calculating the separating matrix (sequential calculations) by using Frame(i+1) corresponding to the subsequent time period.

As described above, in both processing (a-1) and (b-1) in sound source separation performed by the first sound source separation unit 10, every time the above-described Frame (exemplary mixed sound signals corresponding to a predetermined time period) is input, all the input signals are used to perform the learning calculations of a predetermined separating matrix W. Then, the resulting separating matrix is used to sequentially perform sound source separation (matrix calculations) in order to generate the separated signal y1i(t).

The learning calculations of the separating matrix W are performed by repeating a series of steps in which, for all or part of Frame, the currently newest separating matrix W is used as the initial working matrix to perform matrix calculations, the separated signal y1i(t) is determined, and the working matrix is corrected (learned) on the basis of Equation (4) described above. Every time learning calculations for each Frame are completed, the separating matrix W to be used in determining the first separated signal y1i(t) is updated with the ultimately obtained working matrix.

If the learning calculations of a separating matrix performed on the basis of the entire single Frame can be completed within the time length of single Frame, sound source separation can be performed on a real-time basis while all the mixed sound signals are being reflected in the learning calculations.

However, with the processing capabilities of currently available calculators, it can be difficult to consistently complete learning calculations (sequential calculations) necessary to ensure a sufficient level of sound source separation performance within the time period (from Ti to Ti+1) of the single Frame, even in the case of FDICA-based sound source separation that can be performed with relatively low computing load.

Therefore, every time a single Frame of mixed sound signals are input, the first sound source separation unit 10 uses all the input signals to perform learning calculations (sequential calculations) of the separating matrix W while, at the same time, setting the maximum number of learning calculations (maximum number of learning times) such that the calculations can be completed within the time length of a single Frame (exemplary setting time). It can be configured such that the first sound source separation unit 10 obtains, through the controller 50, information about the switching state of the multiplexer 30 and sets the maximum number of learning calculations of the separating matrix W such that the calculations can be completed within the time length of a single Frame only in the case where it has been detected that the multiplexer 30 selects the first separated signal y1i(t) generated by the first sound source separation unit 10 as the output signal yi(t). The controller 50 may be configured to control the first sound source separation unit 10 such that the above-described setting of the maximum number of learning calculations can be made.

The maximum number of learning calculations is predetermined, for example, by experiments or calculations according to the capability of a processor that performs the present processing.

When the maximum number of learning calculations is limited to a certain number as described above, a significant change in audio environment and the like cause insufficient learning of the separating matrix and often result in the generation of the first separated signal y1i(t) which has not been subjected to a sufficient degree of sound source separation (identification). However, since the evaluation value ε increases in such a case, the second separated signal y2i(t) can be selected as the output signal yi(t) when the evaluation value ε reaches or exceeds the second threshold value ε2. Thus, the highest possible level of sound source separation performance can be maintained while real-time processing is performed. Therefore, the first and second threshold values ε1 and ε2 are set such that if the evaluation value ε is equal to or more than either one of the first and second threshold values ε1 and ε2, the level of sound source separation performance of the first sound source separation unit 10 is lower than that of the second sound source separation unit 20.

Next, processing of the sound source separation apparatus according to another embodiment of the present invention will be described with reference to time diagrams in FIGS. 4A and 4B.

FIGS. 4A and 4B are time diagrams illustrating the second example of the division of mixed sound signals to be used both in separating matrix calculations and sound source separation in the processing (ICA-BSS) performed by the first sound source separation unit 10.

The second example is characterized in that the number of samples of mixed sound signals to be used in sequential calculations of a separating matrix W performed by the first sound source separation unit 10 is relatively small (i.e., the samples are thinned out).

The second example is the same as the first example in that the mixed sound signals sequentially input are divided at predetermined intervals into “Frames”, and the first sound source separation unit 10 performs sound source separation using a separating matrix on a Frame-by-Frame basis.

FIG. 4A illustrates processing (a-2) in which Frames used in calculating (learning) the separating matrix are different from those used in generating (identifying) separated signals by performing filtering based on the separating matrix. FIG. 4B illustrates processing (b-2) in which same Frames are used in both cases.

As illustrated in FIG. 4A, in processing (a-2), Sub-Frame(i) corresponding to the first portion (e.g., signals input during a predetermined time period from the beginning) of Frame(i), which corresponds to all the mixed sound signals input during the time period from Ti to Ti+1 (period: Ti+1−Ti), is used to calculate (learn) a separating matrix. Then, the resulting separating matrix is used to perform sound source separation (filtering) on Frame(i+1) corresponding to all the mixed sound signals input during the time period from (Ti+1) to (Ti+2). In other words, a separating matrix calculated on the basis of the first portion of the mixed sound signals input during a single predetermined time period is used to perform sound source separation (identification processing) on mixed sound signals input during the subsequent time period. When a separating matrix calculated (learned) by using the first portion of Frame(i) corresponding to a certain time period is used as an initial value (initial separating matrix) in calculating the separating matrix (sequential calculations) by using Frame(i+1) corresponding to the subsequent time period, the convergence of the sequential calculations (learning) can be accelerated, which is preferable.

On the other hand, as illustrated in FIG. 4B, in processing (b-2), Frame(i) corresponding to all the mixed sound signals input during the time period from Ti to Ti+1 is stored while Sub-Frame(i), which is the first portion of Frame(i), is used to calculate (learn) a separating matrix. Then, the resulting separating matrix is used to perform sound source separation (filtering) on the stored Frame(i). Again, it is preferable that a separating matrix calculated (learned) by using Sub-Frame(i), which is a part of Frame(i) corresponding to a certain time period, be used as an initial value (initial separating matrix) in calculating the separating matrix (sequential calculations) by using Sub-Frame(i+1) corresponding to the subsequent time period.

As described above, in both processing (a-2) and processing (b-2), the first sound source separation unit 10 sequentially performs sound source separation, based on a predetermined separating matrix, on a Frame-by-Frame basis to generate the second separated signal y2i(t). On the basis of the first portion of Frame (interval signals), sequential calculations are performed to determine the separating matrix to be subsequently used. The maximum time period within which the sequential calculations are to be performed is limited to a predetermined time period (Ti+1−Ti).

As described above, in the processing performed by the first sound source separation unit 10, signals to be used in sequential calculations (learning calculations) for determining the separating matrix W are limited to the mixed sound signals corresponding to the first portion of each Frame. This allows for real-time processing even if a relatively large number of sequential calculations (learning calculations) are performed (i.e., the maximum number of sequential calculations is set to a relatively large number).

In the embodiment illustrated in FIG. 2, the multiplexer 30 selects a separated signal generated by one of the first and second sound source separation units 10 and 20 as an output signal, according to the evaluation value ε indicating the degree of convergence of the separating matrix W sequentially calculated by the first sound source separation unit 10.

However, the operation of the multiplexer 30 is not limited to this. For example, the multiplexer 30 can be configured such that the switching state set in step S1, where the separated signal y2i(t) generated by the second sound source separation unit 20 is selected as the output signal yi(t), is maintained during the period from the beginning of the initial learning calculation of the separating matrix W in the first sound source separation unit 10 (step S3 in FIG. 2) until the predetermined number of learning calculations is reached or until a predetermined time that allows such a predetermined number of learning calculations to be performed elapses, and subsequently, the separated signal y1i(t) generated by the first sound source separation unit 10 is selected as the output signal yi(t) (step S6 in FIG. 2).

With this configuration (as in the case of the configuration previously described), a separated signal generated by the second sound source separation unit 20 capable of providing a stable sound source separation performance is selected as an output signal during the time period from the beginning of processing until a sufficient degree of convergence of the separating matrix W is achieved (i.e., until the separating matrix W is sufficiently learned) in the first sound source separation unit 10, and subsequently, a separated signal generated by the first sound source separation unit 10 that has achieved a high level of sound source separation performance is selected as an output signal. Thus, sound source separation performance can be maximized while real-time processing can be achieved.

The present invention is applicable to various sound source separation apparatuses.

What is claimed is:

1. A sound source separation apparatus comprising:
a plurality of sound input means for receiving a plurality of mixed sound signals, sound source signals from a plurality of sound sources being overlapped in each of the mixed sound signals;
separating matrix calculating means for sequentially determining a separating matrix by performing learning calculations of the separating matrix, in the process of blind source separation based on independent component analysis using a predetermined time length of the mixed sound signals;
first sound source separating means for sequentially generating a separated signal corresponding to a sound source signal from the plurality of mixed sound signals by matrix calculations using the separating matrix determined by the separating matrix calculating means;
second sound source separating means for sequentially generating a separated signal corresponding to a sound source signal from the plurality of mixed sound signals by performing real-time sound source separation using a method other than the blind source separation based on independent component analysis; and
output switching means for selecting a separated signal generated by the first sound source separating means or a separated signal generated by the second sound source separating means as an output signal.

2. The sound source separation apparatus according to claim 1, wherein, every time a predetermined time period of the mixed sound signals are input, the separating matrix calculating means uses all the input signals to perform the learning calculations of the separating matrix, and the maximum number of the learning calculations is set such that the calculations can be completed within the predetermined time period.

3. The sound source separation apparatus according to claim 1, wherein, every time a predetermined time period of the mixed sound signals are input, the separating matrix calculating means uses the input signals corresponding to a part of the predetermined time period to perform the learning calculations of the separating matrix.

4. The sound source separation apparatus according to claim 1, wherein the output switching means selects a separated signal generated by the second sound source separating means as an output signal, during a time period from the beginning of the initial learning calculation of the separating matrix in the separating matrix calculating means until the predetermined number of learning calculations is reached or until a predetermined time elapses; and subsequently, the output switching means selects a separated signal generated by the first sound source separating means as an output signal.

5. The sound source separation apparatus according to claim 1, wherein the output switching means selects a separated signal generated by the first sound source separating means or a separated signal generated by the second sound source separating means as an output signal, according to the degree of convergence of the learning calculations performed by the separating matrix calculating means.

6. The sound source separation apparatus according to claim 5, wherein, in the determination of switching operation, the output switching means uses different threshold values of the degree of convergence of the separating matrix, depending on whether the separated signal selected as the output signal is switched from the separated signal generated by the first sound source separating means to the separated signal generated by the second sound source separating means, or switched in the opposite direction.

7. The sound source separation apparatus according to claim 1, wherein the second sound source separating means generates the separated signal by performing any one of binary masking, bandlimiting filtering, and beamformer processing.

8. A sound source separation method comprising the steps of:
receiving a plurality of mixed sound signals, sound source signals from a plurality of sound sources being overlapped in each of the mixed sound signals;
sequentially determining a separating matrix by performing learning calculations of the separating matrix, in the process of blind source separation based on independent component analysis using a predetermined time length of the mixed sound signals;
sequentially generating a separated signal corresponding to a sound source signal from the plurality of mixed sound signals by matrix calculations using the separating matrix determined in the step of sequentially determining the separating matrix;
sequentially generating a separated signal corresponding to a sound source signal from the plurality of mixed sound signals by performing real-time sound source separation using a method other than the blind source separation based on independent component analysis; and
selecting a separated signal generated in the step of sequentially generating a separated signal by matrix calculations using the separating matrix determined in the step of sequentially determining the separating matrix or a separated signal generated in the step of sequentially generating a separated signal by performing real-time sound source separation using a method other than the blind source separation based on independent component analysis, as an output signal.
